(19) United States
(12) Patent Application Publication
(10) Pub. No.: US 2002/0106032 A1
(43) Pub. Date: Aug. 8, 2002

(54) Devices for sending and receiving a modulated signal

(76) Inventors: William Navarro, Velizy-Villacoublay (FR); Frederic Gabin, Bagnolet (FR); Jean-Marc Corbel, Paris (FR); David Choukroun, Versailles (FR)

Correspondence Address: Michael L. Kenaga, Piper Marbury Rudnick & Wolfe, P.O. Box 64807, Chicago, IL, 60664-0807, US

(21) Appl. No.: 10/059,902

(22) Filed: Jan. 29, 2002

(30) Foreign Application Priority Data
Feb. 2, 2001 (FR) 01 01419

(51) Int. Cl. H04L 27/00; H04L 27/04; H04L 27/12

(52) U.S. Cl. 375/259; 375/295; 375/316

(57) ABSTRACT

The sender includes a first source of M-ary symbols and a second source of M′-ary symbols, with M′>M>1, for example M=2, M′=8. The frames delivered by one of the sources are interleaved into successive blocks each including symbols obtained from at least two frames. Each block gives rise to a burst of modulated signal produced either by a first modulator of M-ary symbols or by a second modulator of M′-ary symbols. In response to a change of the active source, certain M-ary symbols originating from the first source are converted into M′-ary symbols to produce at least one block of M′-ary symbols submitted to the second modulator and including both symbols from at least one frame delivered by the second source and symbols obtained by conversion of M-ary symbols from at least one frame delivered by the first source.

### BACKGROUND OF THE INVENTION

The present invention relates to the systems for transmission of modulated signals using multiple modulation schemes and an interleaving technique. It applies especially, but not exclusively, to digital mobile radio communication systems.

The interleaving consists in modifying, in a deterministic way, the order of the binary or nonbinary symbols of a sequence to be transmitted. The inverse operation of deinterleaving reestablishes the sequence in its original order.

The interleaving is most often used jointly with a channel coding the object of which is to add redundancy to the symbols to be transmitted, so as to allow the receiver to correct possible transmission errors. The interleaver is typically placed between the channel coder and the modulator. In the case of transmission channels with memory, there is a correlation between the probabilities of error on two consecutive symbols, such that errors grouped into packets are observed. The role of the interleaver is then to disperse these error packets in order to enhance the performance of the channel decoder.

When the interleaving period is increased, the performance of the channel decoder is enhanced, but the transmission delays due to the interleaving and deinterleaving processes are also increased. The type and the parameters of the interleaver adopted result from a compromise between the behavior in the presence of errors and the transmission delay.

To that end, numerous systems use a diagonal interleaver, which takes in input symbols in the form of “frames” delivered by the coder, combines these symbols and supplies them to the modulator in such a way that each input frame is interleaved diagonally with the preceding frame and with the following frame. When the modulator receives “blocks” of successive symbols on the basis of which it produces respective bursts of modulated signal, each block includes symbols arising from at least two consecutive frames.

Such a diagonal interleaving technique is used, for example, in the GSM (“Global System for Mobile communication”) cellular radio communications system, as described in the GSM technical specification 05.03, “Digital Cellular Telecommunications System (Phase 2+); Channel Coding”, version 5.2.0 published in August 1996 by the ETSI (“European Telecommunications Standard Institute”).

Moreover, certain systems use a plurality of modulators, and are capable of changing the modulation type during a communication. Such a change can have several causes:

the communication may include several time-multiplexed logical channels which employ different modulations, adapted to each type of logical channel. This may come about especially if a speech transmission channel in circuit mode is accompanied by a user-data transmission channel in packet mode or by a signaling channel;

the modulation may be modified adaptively as a function of observation of the conditions for transmission of an information flow.

Such changes of modulation may come about, according to various scenarios, especially in the radio-access networks of GERAN type (“GSM Evolution Radio Access Network”), a general description of which is given in the technical specification 3GPP TS 43.051, “GSM/EDGE Radio Access Network (GERAN), Overall Description—Stage 2 (Release 4)”, version 4.0.0, published in November 2000 by the 3GPP (3rd Generation Partnership Project”).

This capability of changing modulation poses difficulties when the system uses an interleaving which produces blocks to be modulated including symbols obtained from several frames, such as a diagonal interleaving.

Upon a transition of modulation, the frames supplied to the interleaver just before and just after the transition are composed of symbols of a different nature which are intended for the two modulators. These symbols cannot be interleaved in a single block which will be supplied to one of the modulators. Stuffing symbols therefore have to be inserted into a few blocks transmitted just after the transition, which introduces a delay of one or more frames in the transmission of the information.

When the symbols transmitted after the modulation transition represent real-time information, for example coded speech, such a delay is not acceptable, so that there is a loss of the first frame (at least) following the transition, the frame being replaced by a stuffing frame in order to accommodate the change of modulation. In the example of speech transmission, this may cause the loss of syllables onsets following a period of silence, if these periods of silence are made use of to transmit other information according to a different modulation.

An object of the present invention is to overcome the above difficulty.

### SUMMARY OF THE INVENTION

The invention thus proposes a device for sending a modulated signal, comprising a plurality of digital symbol sources, interleaving means for receiving frames of successive symbols delivered by an active source and for generating blocks of successive interleaved symbols each including symbols obtained from at least two frames, and modulation means for generating a burst of modulated signal in response to each block delivered by the interleaving means. The plurality of sources include at least one first source of M-ary symbols and at least one second source of M′-ary symbols, M and M′ being integers such that M′>M>1. The modulation means include a first modulator generating a signal burst in response to a block of M-ary symbols and a second modulator generating a signal burst in response to a block of M′-ary symbols. This device according to the invention further comprises means for conversion of M-ary symbols into M′-ary symbols, and means for selectively activating the conversion means in response to a change of the active source in such a way that the interleaving means generate at least one block of interleaved M′-ary symbols including both symbols from at least one frame delivered by the second source and symbols obtained by conversion of M-ary symbols from at least one frame delivered by the first source.

By virtue of the symbol conversion carried out temporarily, the blocks supplied by the interleaving means are uniform before and after the change of active source and of modulation, without it having been necessary to delay or discard frames.

The symbol conversion carried out upon a change of active source amounts to applying a redundant code to these symbols. This can be achieved by converting each M-ary symbol into an M′-ary symbol constrained to allow only M of the M′ possible values of the M′-ary symbols. This redundancy makes it possible to compensate for the generally lower robustness of the M′-ary modulation to the transmission errors. Hence the frames of M-ary symbols benefit substantially from the same level of protection against errors.

Another aspect of the present invention relates to a device for receiving a signal modulated in the form of successive frames which carries out the dual operations of the abovementioned sending device. This receiving device comprises detection means for identifying a type of modulation of each burst from among a first type of modulation of M-ary symbols and a second type of modulation of M′-ary symbols, M and M′ being integers such that M′>M>1, a first demodulator generating a block of M-ary symbols estimated in response to each signal burst for which the first type of modulation has been identified, a second demodulator generating a block of M′-ary symbols estimated in response to each signal burst for which the second type of modulation has been identified, deinterleaving means for receiving the blocks delivered successively by the demodulators and generating frames of successive symbols such that the estimated symbols of each block procure symbols in at least two frames, first means of processing frames of M-ary symbols, and second means of processing frames of M′-ary symbols. The receiving device further comprises means for conversion of M′-ary symbols into M-ary symbols, and means for selectively activating the conversion means in response to a change in the type of modulation identified so that M′-ary symbols extracted from at least one block delivered by the second demodulator are placed in at least one frame supplied to the second processing means and so that M-ary symbols obtained by conversion of other M′-ary symbols extracted from said block are placed in at least one frame supplied to the first processing means.

### BRIEF DESCRIPTION OF THE DRAWINGS

FIGS. 1 and 2 are respective block diagrams of sending and receiving devices according to the invention.

FIGS. 3 and 4 are diagrams illustrating the formation of the blocks of symbols in a sending device not implementing the invention.

FIGS. 5 and 6 are diagrams similar to those of FIGS. 3 and 4 in the case of a sending device according to FIG. 1 implementing the invention.

### DESCRIPTION OF PREFERRED EMBODIMENTS

The invention is described below in its nonlimiting application to a radio network of GERAN type. The GERAN networks use two types of modulation:

a binary modulation of GMSK type (“Gaussian Minimum Shift Keying”) similar to that used in the traditional GSM networks, in which each input symbol is one bit (M=2 possible values); and

an octal modulation of 8-PSK type (“Phase Shift Keying” with eight states), sometimes called EDGE (“Enhanced Data for GSM Evolution”), in which each input symbol is a triplet of bits (M′=2³=8 possible values).

At the outset, the 8-PSK modulation was introduced more particularly for packet-mode data channels, the GMSK modulation serving rather for circuit-mode speech-transmission channels.

Given that a speech channel can coexist with a packet-mode data channel for a given user, it is possible to have situations in which the channel multiplexing requires a change of modulation during a communication. The communication may switch to packet mode (8-PSK) in the course of a telephone conversation (GMSK) in order to transmit user data or signaling.

These data may have priority, in which case their transmission in 8-PSK can be done by cutting off the speech transmitted in GMSK. This may be the case, for example, for the signaling of the SIP protocol (“SIP: Session Initiation Protocol”, Request for Comments 2543 published in March 1999 by the Internet Engineering Task Force).

These data may also not have priority (“best effort”), in which case they are transmitted during the pauses in the speech by a discontinuous-transmission mechanism (DTX) . This may be the case, for example, for messages or Web documents transmitted as a background task of a telephone communication.

The GMSK modulation may also be used to transmit data, especially signaling data, on a logical channel of FACCH type (“Fast Associated Control CHannel”).

Furthermore, provision has been made for 8-PSK modulation to serve also for transmitting speech (or other) signals in circuit mode. This latter case arises especially in the context of the adaptive multi-rate speech coder (AMR: “Adaptive Multi-Rate”, see technical specification 3G TS 26.090, version 3.1.0, published in December 1999 by the 3GPP). The AMR coders offer a diversity of source coding rates to which, in the GERAN networks, are added channel coding diversity and modulation diversity (GMSK or 8-PSK) . The output rate of the source coder, the coding rate of the channel coder and the choice of the modulation can be adapted as a function of the observed quality of the speech communication, which depends especially on radio-propagation conditions. Hence, AMR-coded speech may, in the course of communication, be switched from a GMSK traffic channel to an 8-PSK traffic channel and vice versa.

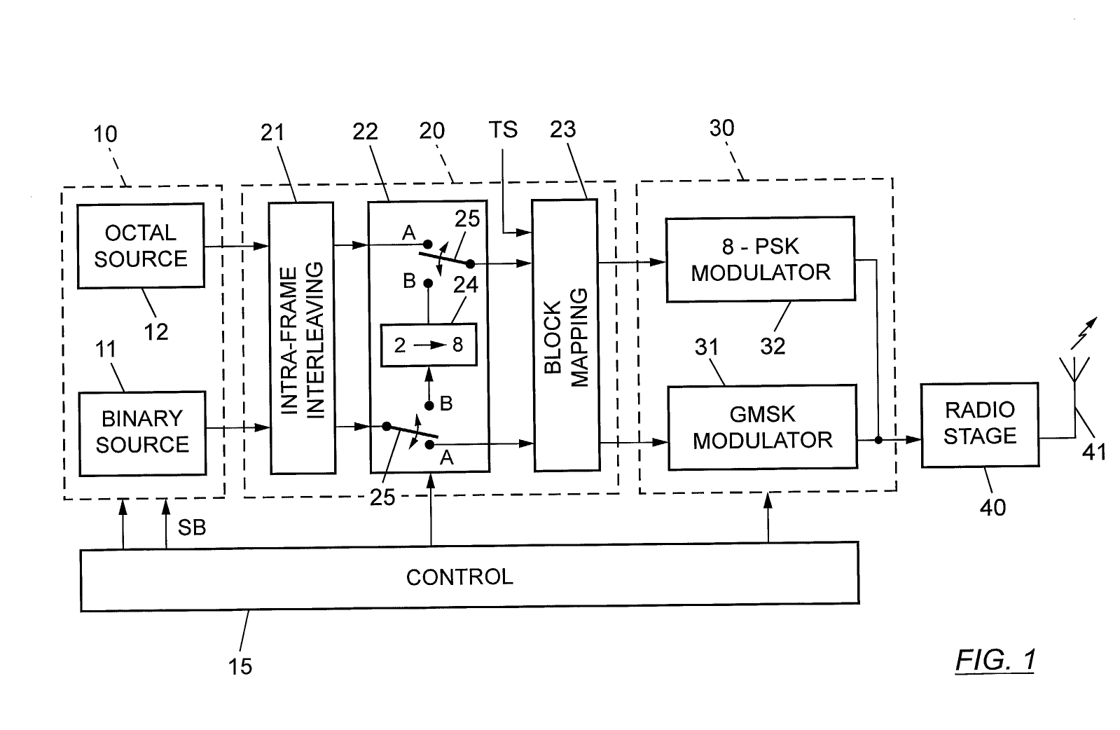

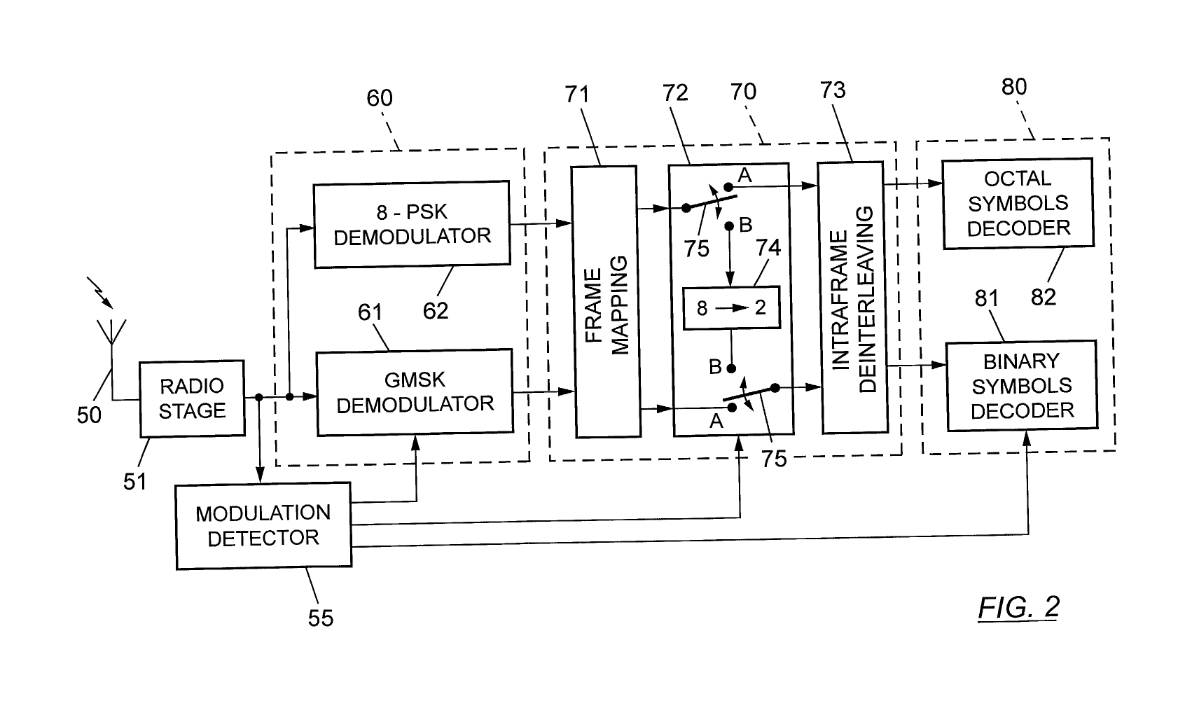

In the downlink case in a GERAN network, the sender of FIG. 1 is located in a base station of the network, and the receiver of FIG. 2 is located in a compatible mobile station. In the uplink case, the sender of FIG. 1 is located in the mobile station, and the receiver of FIG. 2 in the base station.

In the diagram of FIG. 1, reference 10 designates the stage of production of the digital symbols to be transmitted to the receiver. This stage 10 includes a binary source 11 generating bits intended to be modulated in GMSK, and an octal source 12 generating triplets of bits intended to be modulated in 8-PSK.

Each represented source 11, 12 incorporates the channel coder which, as appropriate, carries out a redundant coding of the information so as to protect it against transmission errors.

The two sources 11, 12 may come under the same logical channel or different logical channels. There may also be more than one binary source and/or more than one octal source.

A control unit 15 selects the source of symbols 11, 12 which is active at a given instant, on the basis of the criteria set out above (flow multiplexing, adaptive modulation, etc.).

In the traffic channels of the GERAN networks, the radio signal is transmitted in the form of successive bursts produced by modulating respective blocks each composed of 26 symbols, known a priori, forming a training sequence TS, and of 116 information symbols including 2 signaling symbols SB.

The type of physical channel to which a burst relates is defined on the basis (i) of signaling exchanged beforehand between the sender and the receiver in order to define the type of resource, (ii) of the type of modulation employed (GMSK or 8-PSK), and (iii) of the patterns of signaling symbols SB inserted into the transmitted frames.

Each frame of information symbols delivered by a source 11, 12 includes p×116 symbols, in which the number p depends on the type of channel established. By way of example, the GERAN specifications provide for the value p=4 for full-rate traffic channels with the wideband AMR coder (called TCH/WFS when the modulation is GMSK and O-TCH/WFS when the modulation is 8-PSK) and p=2 for the half-rate AMR traffic channels (called TCH/AHS in GMSK modulation and O-TCH/AHS in 8-PSK modulation).

The pattern of p×2 signaling symbols SB (binary or octal symbols) of a frame, defined by the control unit 15, specifies the channel coding type and rate used in the source 11 or 12. It also indicates whether the current frame is stolen to belong to an associated signaling channel of FACCH or O-FACCH type. Depending on the characteristics of the channel, the control unit 15 supplies the active source 11, 12 with the relevant parameters of the channel coder, and also delivers the signaling symbol pattern SB to be inserted into the current frame.

The interleaver 20 represented in FIG. 1 includes an intraframe interleaving module 21, which applies a pseudo-random combination of the symbols within each frame delivered by the active source. This combination is the same when the symbols manipulated are binary or octal. The interleaver 20 further includes a coding module 22 which will be described later on, and a block mapping module 23 which distributes the interleaved symbols into the blocks supplied to the modulation stage 30, while inserting the training sequence TS into each block.

This mapping operation carries out the diagonal interleaving: the p×116 symbols of each interleaved frame are distributed into 2p sub-frames of 58 symbols, and the symbols of the k^{th} sub-frame (1≦k≦p) of each i-rank frame are transmitted in a block of rank ip+k with the symbols of the (p+k)^{th} sub-frame of the preceding frame of rank i−1. The mixing of the information symbols originating from the two consecutive frames is carried out by placing the symbols of the frame of rank i at the even positions and the symbols of the frame of rank i−1 at the odd positions in the blocks of ranks ip+1 to (i+1)p.

Each output block from the interleaver 20 is supplied to one of the two modulators of the stage 30, namely the GMSK modulator 31 if the symbols of the block are binary and the 8-PSK modulater 32 if they are octal. The resulting modulated signal is handled conventionally by the circuits of the radio stage 40 before being sent via the antenna 41 of the sender.

Correspondingly, the radio signal picked up by the antenna 50 of the receiver is dealt with by the circuits of the radio stage 51 before being subjected to the demodulation stage 60. The stage 60 makes use of the training sequence TS to acquire the radio synchronization and to estimate the relevant parameters of the propagation channel for demodulation. It includes a GMSK demodulator 61 and an 8-PSK demodulator 62.

The deinterleaver 70 receives the blocks of estimated symbols delivered successively by the demodulation stage 60. It includes a module 71 for mapping on the frames which distributes the estimated symbols from the blocks received following the successive frames, a decoding module 72 which will be described later on and an intraframe deinterleaving module 73 which applies to the symbols of each frame the combining operation which is the inverse of that applied by the module 21 of the interleaver 20.

The processing stage 80 receives the successive deinterleaved frames. In particular, it includes two channel decoders 81, 82 associated with the sources 11, 12 for the binary symbols and for the octal symbols, respectively. The decoding mode which is to be applied to the current frame is identified on the basis of the type of symbols received (binary or octal) and of the signaling symbol pattern SB found in the frame.

In a way which is known in the GERAN networks, a modulation-type detector 55 co-operates with the demodulation stage 60 to determine which of the demodulators 61 and 62 has to be used for the current burst. This detector 55 observes the phase shifts in the received radio signal to determine whether the burst is modulated in GMSK (shifts of ±π) or in 8-PSK (shifts whole multiple of π/4) . The indication is also supplied to the decoding module 72, and to the processing module 80 in order to activate either the decoder 81 or the decoder 82.

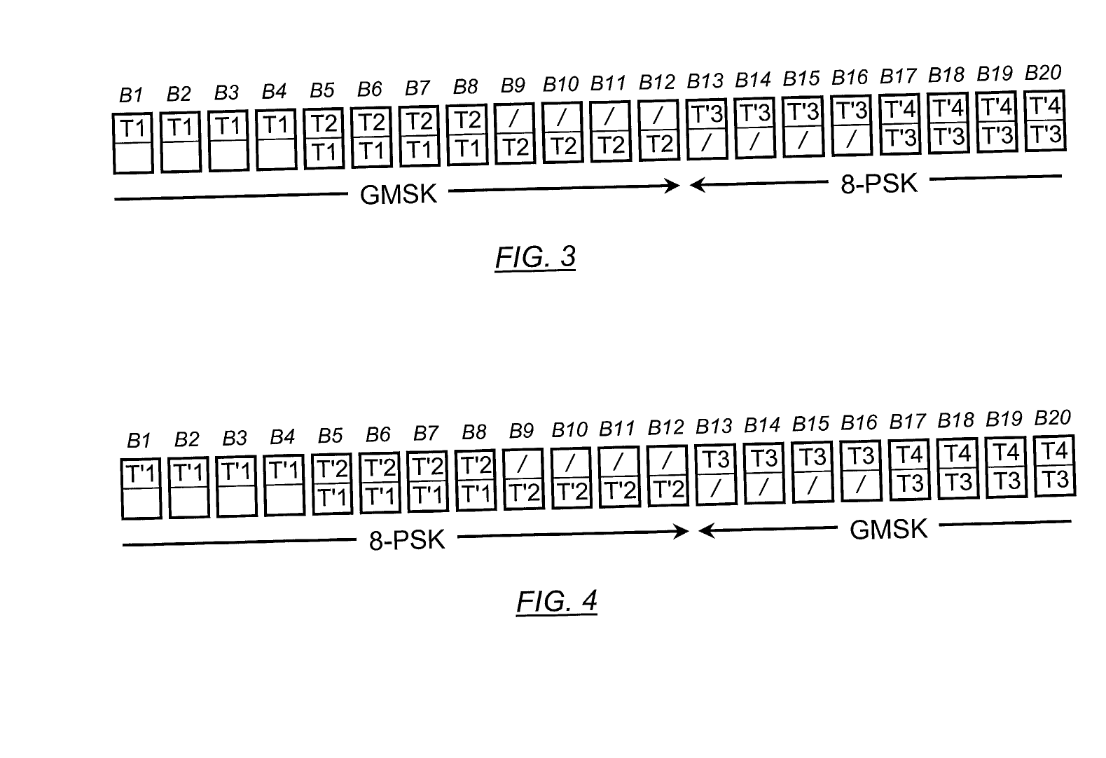

The diagonal interleaving poses a problem at the points in time when the control unit 15 modifies the active signal source. In one example, in which each frame extends over 2p=8 blocks, FIG. 3 illustrates the case where the octal source 12 (frames T′i with i=1, 2, etc.) replaces the binary source 11 (frames Tj with j=1, 2, etc.), while FIG. 4 illustrates the case where the binary source 11 replaces the octal source 12. Each block Bq consists of homogeneous symbols arising from two consecutive frames Ti, T(i+l) or T′j, T (j+1) as long as the active source is not changed.

In the illustration, the change of source occurs between the start of sending of the block B5 and that of the block B9. It is necessary to terminate the sending of the frame which has been started (T2 in FIG. 3, T′2 in FIG. 4). In the absence of specific provisions, the corresponding modulation (GMSK in FIG. 3, 8-PSK in FIG. 4) has to be maintained until the block B12, and the first frame of the new source (T′3 in FIG. 3, T3 in FIG. 4) has to wait for the change of modulation, i.e. block B13, to be sent. That assumes that p sub-frames of stuffing symbols are inserted into the symbol flow before and after the change of modulation, as illustrated by the “/” sign in FIGS. 3 and 4. This results in a transmission delay of one frame, or the loss of a frame of the new source if it produces a real-time signal.

The coding and decoding modules 22, 72 are for the purpose of overcoming this drawback.

The module 22 includes a converter 24 which converts a binary symbol into an octal symbol. The module 72 includes a converter 74 which reciprocally converts an octal symbol into a binary symbol. This conversion associates the two values of a bit (0 and 1) with two diametrally opposed phase shifts of the 8-PSK constellation, respectively. This constellation respectively allocates the phase-shift values 0, π/4, π/2, 3π/4, π, 5π/4, 3π/2 and 7π/4 to the triplets of bits (1, 0, 1), (1, 0, 0) and (1, 1, 0). The converter 24 can thus, for example, convert the bit 0 into the triplet (0, 0, 1) and the bit 1 into the triplet (1, 1, 1). It should be noted that other binary/octal conversion modes can be used.

The converters 24, 74 are activated selectively in response to the changes of active source. This activation is shown diagrammatically by the position B of the changeover switches 25 and 75 in FIGS. 1 and 2, the position A corresponding to the direct exchange of the interleaved frames between the mapping module and the intraframe interleaving/deinterleaving module.

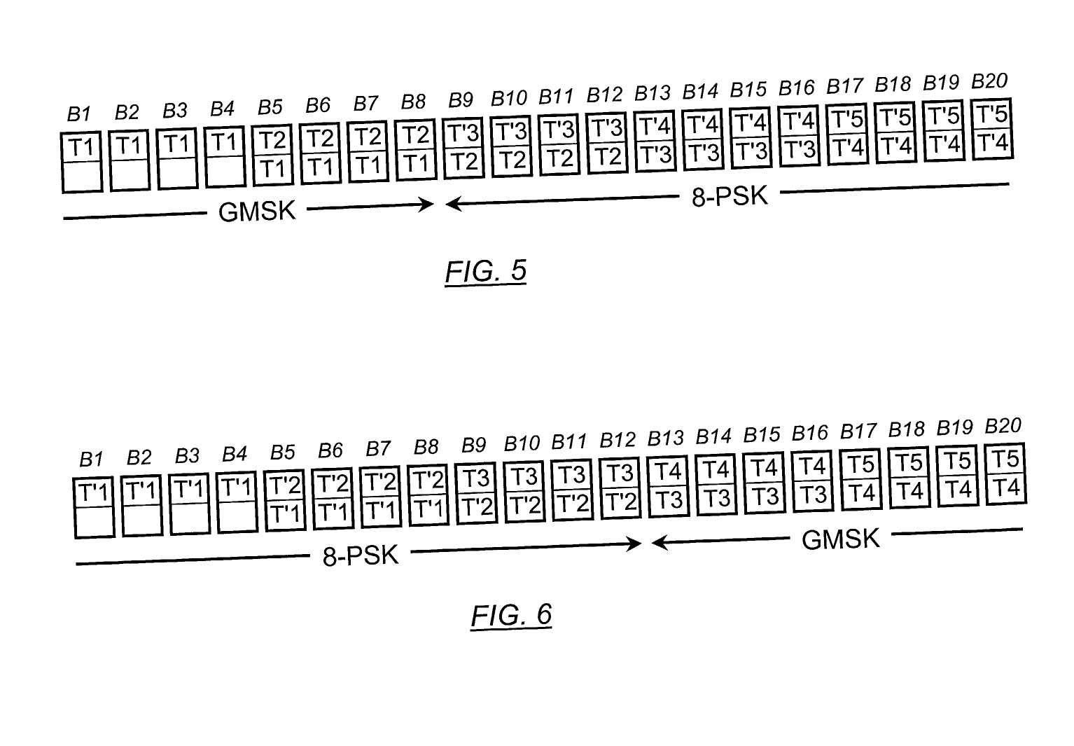

The activation of the converter 24 of the sender is controlled by the unit 15 for p sub-frames originating from the binary source 11, which represents half of a frame and corresponds to the duration of sending of p blocks. These p blocks are those (B9 to B12 in FIGS. 5 and 6) which follow the group of p blocks (B5 to B8) during the sending of which the change of active source has occurred. The frames originating from the new source can start to be transmitted as from these p blocks B9-B12, which each carry symbols originating from the two sources 11, 12 (sub-frames T2 and T′3 in FIG. 5, sub-frames T3 and T′2 in FIG. 6). No stuffing symbol is required, which avoids the undesirable delays.

In the case of a binary source→octal source transition (FIG. 5), the unit 15 controls the change of modulation GMSK→8-PSK upon activation of the converter 24 (as from the block B9). In the case of an octal source→binary source transition (FIG. 6), the unit 15 controls the change of modulation 8-PSK→GMSK after the end of activation of the converter 24 (from the block B13). Therefore, the mixed blocks are always transmitted in 8-PSK.

At the receiver end, the converter 74 is activated in response to the changes of modulation detected by the module 55.

When a change of modulation GMSK→8-PSK is detected between two consecutive blocks Bq and B(q+1), the converter 74 is activated for the remaining p sub-frames of the last binary frame T2, which are received in the blocks B(q+1) to B(q+p) (B9 to B12 in FIG. 5).

When a change of modulation 8-PSK→GMSK is detected between two consecutive blocks Bq and B(q+1), the converter 74 is activated for the p sub-frames already received of the first binary frame T3. These p sub-frames were received in the form of octal symbols (0, 0, 1) and (1, 1, 1) in the blocks B(q−p+1) to B(q) (B9 to B12 in FIG. 6) and stored temporarily in a buffer memory of the mapping module 71 while awaiting the missing sub-frames. They can therefore be submitted to the converter 74 after reception of these missing sub-frames.

Thus, the deinterleaver 70 extracts from the mixed blocks B9 to B12 delivered by the 8-PSK demodulator 62, on the one hand, octal symbols placed in a frame (T′3 in FIG. 5, T′2 in FIG. 6) supplied to the decoder 82, and on the other hand, octal symbols which, after conversion into binary symbols, are placed in a frame (T2 in FIG. 5, T3 in FIG. 6) supplied to the decoder 81.

1. A device for sending a modulated signal, comprising:
a plurality of digital symbol sources including at least one first source of M-ary symbols and at least one second source of M′-ary symbols, M and M′ being integers such that M′>M >1;
interleaving means for receiving successive symbol frames delivered by an active source of said plurality of sources and for generating blocks of successive interleaved symbols each including symbols obtained from at least two frames;
modulation means for generating a burst of modulated signal in response to each block delivered by the interleaving means, the modulation means including a first modulator generating a signal burst in response to a block of M-ary symbols and a second modulator generating a signal burst in response to a block of M′-ary symbols;
conversion means for converting M-ary symbols into M′-ary symbols; and
means for selectively activating the conversion means in response to a change of the active source so that the interleaving means generate at least one block of interleaved M′-ary symbols including both symbols from at least one frame delivered by the second source and symbols obtained by conversion of M-ary symbols from at least one frame delivered by the first source.

2. The device as claimed in claim 1, wherein the conversion means are arranged to convert an M-ary symbol originating from the first source into an M′-ary symbol constrained to allow only M of the M′ possible values of the M′-ary symbols.

3. A device for receiving a signal modulated in the form of successive bursts, comprising:
detection means for identifying a type of modulation of each burst from among a first type of modulation of M-ary symbols and a second type of modulation of M′-ary symbols, M and M′ being integers such that M′>M >1;
a first demodulator for producing a block of M-ary estimated symbols in response to each signal burst for which the first type of modulation has been identified;
a second demodulator for producing a block of M′-ary estimated symbols in response to each signal burst for which the second type of modulation has been identified;
deinterleaving means for receiving the blocks successively produced by the demodulators and for generating frames of successive symbols such that the estimated symbols of each block provide symbols in at least two frames;
first processing means for processing frames of M-ary symbols;
second processing means for processing frames of M′-ary symbols;
conversion means for converting M′-ary symbols into M-ary symbols; and
means for selectively activating the conversion means in response to a change in the identified type of modulation so that M′-ary symbols extracted from at least one block produced by the second demodulator are placed in at least one frame supplied to the second processing means and so that M-ary symbols obtained by conversion of other M′-ary symbols extracted from said block are placed in at least one frame supplied to the first processing means.

4. The device as claimed in claim 3, wherein the conversion means are arranged to convert an M′-ary symbol constrained to allow only M of the M′ possible values of the M′-ary symbols into an M-ary symbol.
